(19) United States
(12) Patent Application Publication
(10) Pub. No.: US 2009/0244380 A1
(43) Pub. Date: Oct. 1, 2009

(54) Television Broadcast Receiving Apparatus and Television Setting Method

(75) Inventor: Yukio Mori, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/333,948

(22) Filed: Dec. 12, 2008

(30) Foreign Application Priority Data
Mar. 27, 2008 (JP) 2008-083593

(51) Int. Cl. H04N 5/50

(52) U.S. Cl. 348/569; 348/E05.097

(57) ABSTRACT

According to one embodiment, a television broadcast receiving apparatus has a recording module that records setting information set in regard to a plurality of setting items, a display that displays a setting screen required to set setting values of the plurality of setting items, a setting input module that input the setting information in the setting screen to set the setting values of the plurality of setting items displayed in the display, an acquiring module that acquires a setting code associated with the plurality of setting items in the setting screen, a setting code input module that input the setting code, and a setting value setting module that sets the setting values of the plurality of setting items in association with the setting code input from the setting code input module.

### CROSS-REFERENCE TO RELATED APPLICATIONS

This application is based upon and claims the benefit of priority from Japanese Patent Application No. 2008-083593, filed Mar. 27, 2008, the entire contents of which are incorporated herein by reference.

### BACKGROUND

1. Field

One embodiment of the invention relates to a television broadcast receiving apparatus and a television setting method, and more particularly to a television broadcast receiving apparatus an a television setting method having improved convenience of function setting.

2. Description of the Related Art

Settings different from those used at home are demanded in a television broadcast receiving apparatus used in rooms provided to be adjacent to each other in, e.g., a hotel.

For example, a function of forcibly switching to a video input terminal connected with a set-top box at the time of turning on a power supply of a television broadcast receiving apparatus or a function of restricting hotel guests to change content subjected to channel setting has been demanded so that a maximum sound volume output restricting function considering sound leakage to neighboring rooms or a CATV set-top box for enabling reception of a hotel's unique broadcast can be utilized simultaneously with turning on the power supply of the television broadcast receiving apparatus. In regard to such hotel settings, a special operation method using a dedicated remote controller or signal or a regular remote controller must be used to display a setting screen, and each setting must be configured out in accordance with each television receiving apparatus.

JP-A H6-261266 (KOKAI) discloses a structure in which a maximum sound volume restriction can be set by mounting a microcomputer that can set a hotel special function on a television broadcast receiving apparatus and simultaneously pressing, e.g., a remote controller and a control panel provided in the television broadcast receiving apparatus, thereby satisfying a specification of each hotel with one model.

However, according to the conventional apparatus, configuring a plurality of settings, e.g., a maximum sound volume restriction or a channel setting at the time of turning on a power supply with respect to one apparatus in a single hotel is very complicated in the hotel where the settings must be configured with respect to many television broadcast receiving apparatuses.

It is, therefore, an object of the present invention to provide a television broadcast receiving apparatus and a television setting method that can readily configure settings when the same settings are configured in the plurality of television broadcast receiving apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view showing an appearance of a television broadcast receiving apparatus according to an embodiment;

FIG. 2 is a structure explanatory drawing specifically showing the inside of the television broadcast receiving apparatus according to the embodiment;

FIG. 3 is an explanatory view for explaining an outline of a remote controller used in the apparatus according to the embodiment;

FIG. 4 is a view showing a hotel mode setting screen displayed on the television broadcast receiving apparatus according to the embodiment;

FIG. 5 is a view showing setting items used in hotel mode setting according to the embodiment;

FIG. 6 is a view showing setting items used in the hotel mode setting according to the embodiment;

FIG. 7 is a view showing a hotel mode copy setting screen displayed on the television broadcast receiving apparatus according to the embodiment; and

FIG. 8 is a flowchart for explaining a hotel mode copy setting according to the embodiment.

### DETAILED DESCRIPTION

Various embodiments according to the invention will be described hereinafter with reference to the accompanying drawings. In general, according to one embodiment of the invention, a television broadcast receiving apparatus has a recording module that records setting information set in regard to a plurality of setting items, a display that displays a setting screen required to set setting values of the plurality of setting items, a setting input module that input the setting information in the setting screen to set the setting values of the plurality of setting items displayed in the display, an acquiring module that acquires a setting code associated with the plurality of setting items in the setting screen, a setting code input module that input the setting code, and a setting value setting module that sets the setting values of the plurality of setting items in association with the setting code input from the setting code input module.

An embodiment will now be explained hereinafter with reference to the drawings. An outline of a broadcast receiving apparatus will be first explained.

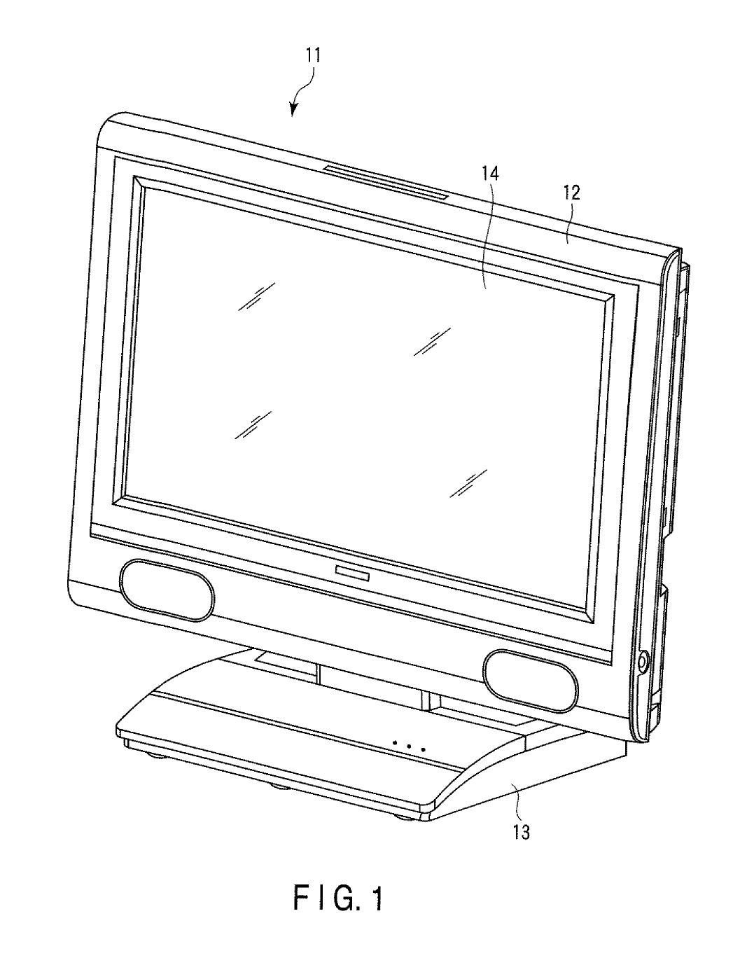

FIG. 1 shows an appearance of a television receiving apparatus 11 according to an embodiment. The television broadcast receiving apparatus 11 is formed of a thin cabinet 12 and a support pedestal 13 that supports this cabinet 12 in an upright posture. To the cabinet 12 are disposed a planar panel type picture display 14 formed of, e.g., a liquid crystal display panel, a speaker 15, an operating module 16, an optical receiving module 18 that receives operation information transmitted from a remote controller 17, and others.

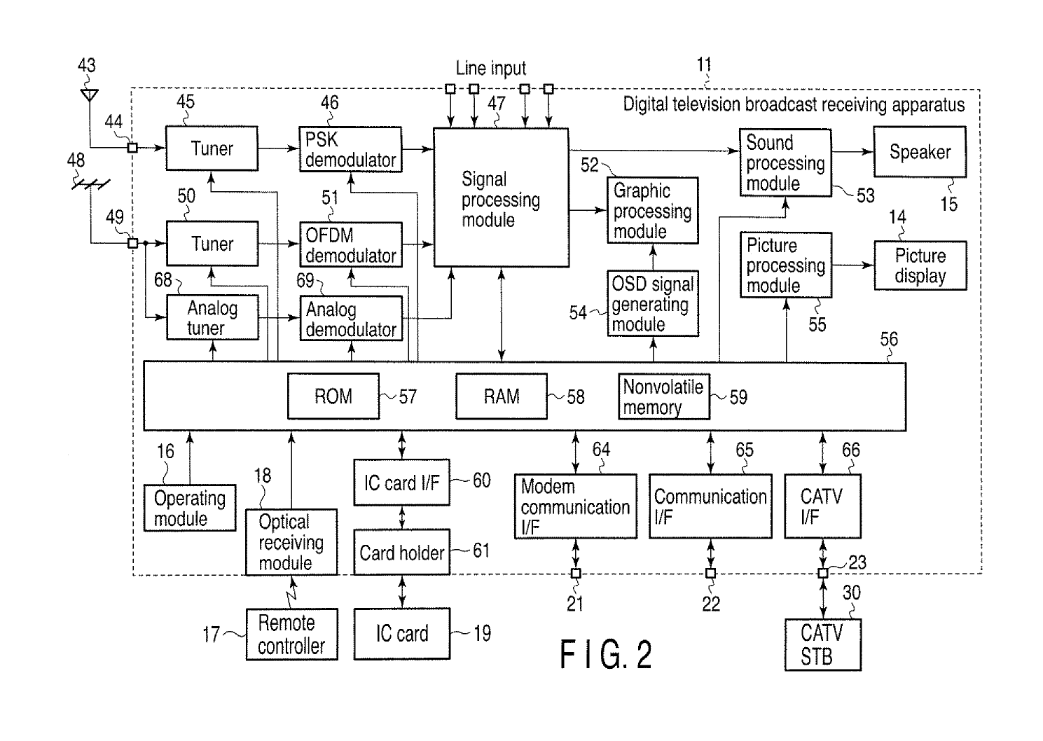

FIG. 2 shows a primary signal processing system of the television broadcast receiving apparatus 11. That is, when a satellite digital television broadcast signal received through a BS/CS digital broadcast receiving antenna 43 is supplied to a satellite digital broadcast tuner 45 through an input terminal 44, a broadcast signal of a desired channel is selected.

The broadcast signal selected by the tuner 45 is supplied to a PSK (Phase Shift Keying) demodulator 46 to be demodulated into a digital picture signal and a digital audio signal, and the demodulated signals are output to a signal processing module 47.

Furthermore, an analog tuner 68 that receives a terrestrial analog signal is also provided. A signal received by the analog tuner 68 is demodulated by an analog demodulator 69 to be output to the signal processing module 47.

Moreover, a terrestrial digital television broadcast signal received by a terrestrial digital broadcast receiving antenna 48 is supplied to a terrestrial digital broadcast tuner 50 through an input terminal 49, thereby selecting a broadcast signal of a desired channel.

A broadcast signal selected by the tuner 50 is supplied to an OFDM (Orthogonal Frequency Division Multiplexing) demodulator 51 to be demodulated into a digital picture signal and a digital audio signal, and the demodulated signals are output to the signal processing module 47.

Here, the signal processing module 47 selectively performs predetermined digital signal processing with respect to the digital picture signal and the digital audio signal fed from the PSK demodulator 46, the digital picture signal and the digital audio signal supplied from the OFDM demodulator 51, the picture signal and the audio signal fed from the analog demodulator 69, and a picture signal and an audio signal supplied from each line input terminal, and outputs the processed signals to a graphic processing module 52 and an audio processing module 53.

Of these modules, the graphic processing module 52 has a function of superimposing an OSD signal generated by an OSD (On screen Display) signal generating module 54 on the digital picture signal supplied from the signal processing module 47 and outputting the obtained signal. Additionally, this graphic processing module 52 can selectively output the output picture signal from the signal processing module 47 and the output OSD signal from the OSD signal generating module 54, and can combine and output both the outputs to configure respective halves of a screen.

The digital picture signal output from the graphic processing module 52 is supplied to a picture processing module 55. This picture processing module 55 converts the input digital picture signal into an LVDS (Low Voltage Differential Signaling) signal having a format that can be displayed in the picture display 14, and outputs the converted signal to the picture display 14 to display a picture.

The audio processing module 53 converts the input digital audio signal into an analog audio signal having a format can be reproduced by the speaker 15, and outputs the converted signal to the speaker 15 to reproduce sound.

Here, all operations of this television broadcast receiving apparatus 11 including the above-explained various receiving operations are collectively controlled by a control module 56.

The control module 56 has a built-in central processing module (CPU) and others. Upon receiving operation information from the operating module 16 or receiving operation information supplied from the remote controller 17 via the optical receiving module 19, the control module 56 controls respective modules to reflect the operation contents in the apparatus.

In this case, the control module 56 mainly utilizes a read-only memory (ROM) 57 that stores a control program executed by the CPU, a random access memory (RAM) 58 that provides a working area to the CPU, and a nonvolatile memory 59 storing various kinds of setting information, control information, and other items. The control module 56 executes, e.g., reading or writing screen information of a hotel mode setting screen 70 and a hotel mode copy setting screen 80 which are recorded in the nonvolatile memory 59 and will be explained later after.

The control module 56 is connected with a card holder 61 to which an IC card 19 can be attached through an IC card interface 60. As a result, a viewer number or a decryption key stored in the IC card 19 are read to be collated with decryption conditions in a signal transmitted through digital broadcasting, and a decryption key of the signal processing module 47 is supplied.

The control module 56 is connected with a telephone line terminal 21 through a modem communication interface 64 and also connected with an LAN terminal 22 via a communication interface 65. The LAN terminal 22 is connected with an Internet line through a device such as a broadband router. This is used as bi-directional apparatus in a bi-directional data broadcast service to transmit accounting information to a number supply company when receiving a pay-television broadcast in digital broadcasting, for example.

Further, the control module 56 is also connected with a CATV connection terminal 23 through a CATV interface 66. The CATV connection terminal 23 is used to input picture information from a CATV set-top box 30 as an external device.

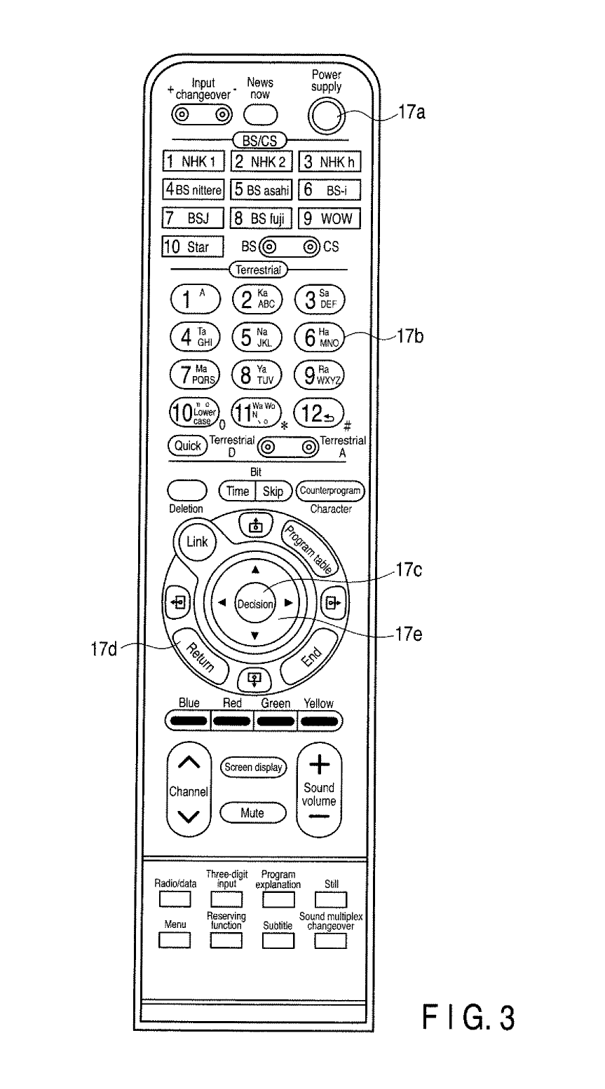

FIG. 3 shows an appearance of the remote controller 17. On this remote controller 17 are mainly provided a power supply key 17a, a channel selection key 17b, a decision key 17c, a return key 17d, and an arrow key 17e.

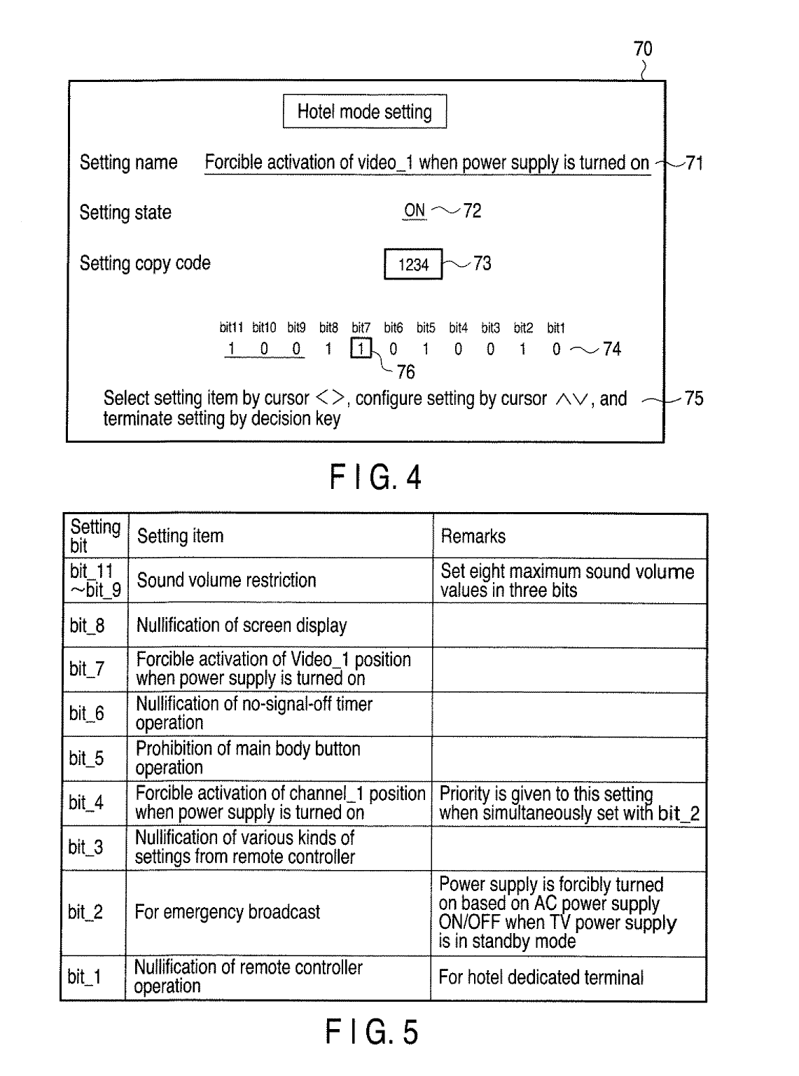

An embodiment will now be explained. FIG. 4 shows a setting screen that is used to set a hotel mode in regard to the television receiving apparatus 11.

A setter (e.g., an employee of a hotel) can input an instruction to display the hotel mode setting screen 70 depicted in FIG. 4 in the picture display 14 based on a special operation combining the remote controller 17 and the operating module 16 of the television broadcast receiving apparatus 11. When the instruction to display the hotel mode setting screen 70 is input, the control module 56 transmits screen information of the hotel mode setting screen 70 in the picture display 14 to the picture processing module 55 based on control information recorded in the nonvolatile memory 59, and the picture processing module 55 displays this screen.

Display of such a hotel mode setting screen 70 is determined as a special operation because a menu like the hotel mode setting screen 70 is prepared in the nonvolatile memories 59 in all the television broadcast receiving apparatuses 11 without discriminating the generally commercially available television broadcast receiving apparatus 11 from the television broadcast receiving apparatus 11 for hotels.

Therefore, when the generally commercially available television broadcast receiving apparatus 11 is used as it is in hotels, it can be easily utilized as the television broadcast receiving apparatus 11 for hotels. Therefore, the control module 56 reads screen information of the hotel mode setting screen 70 from the nonvolatile memory 59 based on the special operation alone to prevent the hotel mode setting screen 70 from being used at home.

The hotel mode setting screen 70 displayed in the picture display 14 will now be explained. In the hotel mode setting screen 70 are displayed a setting name column 71, a setting state column 72, a setting copy code column 73, a hotel mode setting item bit list 74, and an operation explanation column 75.

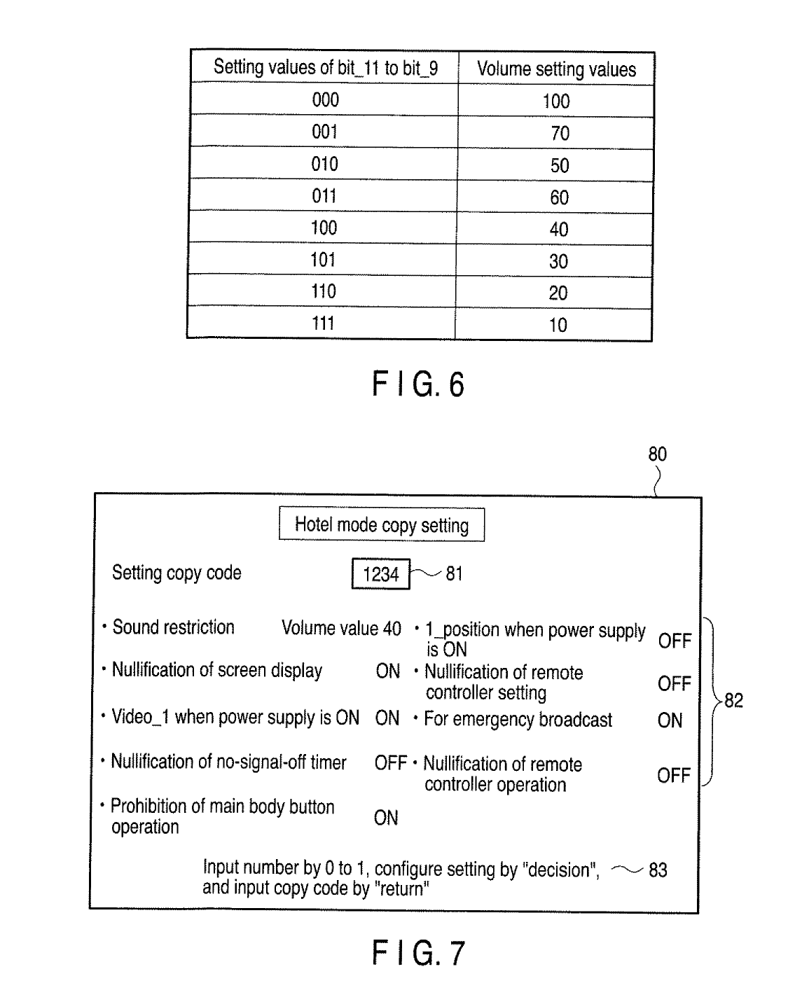

A setter uses the remote controller 17 to set the hotel mode setting item bit column 74. The hotel mode setting item bit list 74 is formed of bit_1 column to a bit_11 column. The respective bit columns indicate setting items depicted in FIG. 6. The bit_11 column to the bit_9 column consist of three bits and indicate a setting item for a sound volume restriction output from the speaker 15 in the television broadcast receiving apparatus 11. This is a sound volume restricting function to be set. Specifically, as shown in FIG. 7, eight maximum sound volume setting values are determined in accordance with combinations of three bits in the bit_11 column to the bit_9 column. In a case where a setting value of a volume output from the speaker 15 in the television broadcast receiving apparatus 11 is 100 at maximum, a volume setting value of a maximum sound volume output from the speaker 15 is 100 when the columns of, e.g., (bit_11, bit_10, and bit_9) have a setting value (0, 0, 0). When the columns of (bit_11, bit_10, and bit_9) have a setting value (1, 1, 1), a volume setting value of a maximum sound volume output from the speaker 15 is 10.

The setter can use the sound volume restricting function based on this setting of three bits in the bit_11 column to the bit_9 column to set a volume setting value of the maximum sound output from the speaker 15, and this is effective for the setting of the volume in a place like a hotel where a great volume causes a nuisance to the neighbors.

Further, a bit_8 column in the hotel mode setting item bit list 74 depicted in FIG. 4 corresponds to a setting item of a setting to disable screen display; a bit_7 column, a setting item of a setting to forcibly select a video_1 input when the power supply is turned on; a bit_6 column, a setting item of a setting to disable a no-signal-off timer operation; a bit_5 column, a setting item of a setting to prohibit operating a main body button; a bit_4 column, a setting item of a setting to forcibly activate a channel_1 position when the power supply is turned on; a bit_3 column, a setting item of a setting to disable various kinds of settings from the remote controller 17; a bit_2 column, a setting item of a setting associated with emergency broadcast; a bit_1 column, a setting item of a setting to disable operations of the remote controller 17. Since the setting items in the bit_8 column to the bit_1 column correspond to the settings of turning on/off functions associated with the respective setting items, they are set with one bit.

The setter can configure the setting in each bit column in the hotel mode setting item bit list 74 as follows by using the remote controller 17 as a setting input module in accordance with an operation explanation 75 displayed in the hotel mode setting screen 70.

At first, when the hotel mode setting screen 70 is displayed in the picture display 14, a cursor 76 is displayed in the bit_1 column in the hotel mode setting item bit list 74. The setter can move the cursor 76 to a bit column corresponding to a desired setting item by pressing a left or right key in the arrow key 17e in the remote controller 17.

Here, in accordance with a bit column where the cursor 76 is shown after movement of the cursor 76, the control module 56 displays a setting item name corresponding to this bit column in the setting name column 71 from information that is recorded in the nonvolatile memory 59 and depicted in FIG. 5. Further, based on which one of “1” and “0” is set in this bit column, the control module 56 displays “ON” in the setting state column 72 when “1” is set and displays “OFF” in the same when “0” is set. Furthermore, based on the setting of “1” or “0” in this bit column, the control module 56 records each bit column and the setting of “1” or “0” in the nonvolatile memory 59 in association with each other. As explained above, since the picture display 14 displays the setting name column 71 and the setting state column 72 associated with the bit column in accordance with movement of the cursor 76, the setter can readily understand the setting method and the setting item.

The setter moves the cursor 76 to the bit column of an item that should be set by using the left or right key in the remote controller 17, and then sets the bit to “1” in order to set the setting item of this bit column to ON and sets the bit to “0” in order to set the same to OFF by using an upward or downward key in the remote controller 17.

For example, as shown in FIG. 4, when the cursor 76 is displayed in the bit_7 column in the hotel mode setting item bit list 74, since “1” is set in this bit column, “ON” is displayed in the setting state column 72, and “Forcible activation of video_1 when power supply is turned on” is displayed in the setting name column 71 as the setting item corresponding to the bit column.

When the setter uses the remote controller 17 to set the hotel mode setting item bit list 74, the control module 56 as an acquiring module converts each binary value in the set hotel mode setting item bit list 74 into a decimal setting copy code. Moreover, when each bit column in the hotel mode setting item bit list 74 is changed, the control module 56 changes the setting copy code converted into a decimal number to be displayed in the setting copy code column 73. Therefore, the setter can visually confirm the setting copy code associated with the set hotel mode setting item bit list 74 in the hotel mode setting screen 70.

When the setting of all the bit columns in the hotel mode setting item bit list 74 is terminated, the setter presses the decision key 17c in the remote controller 17, whereby the control module 56 records this setting in the nonvolatile memory 59 and configures the setting to be applied to the television receiving apparatus 11.

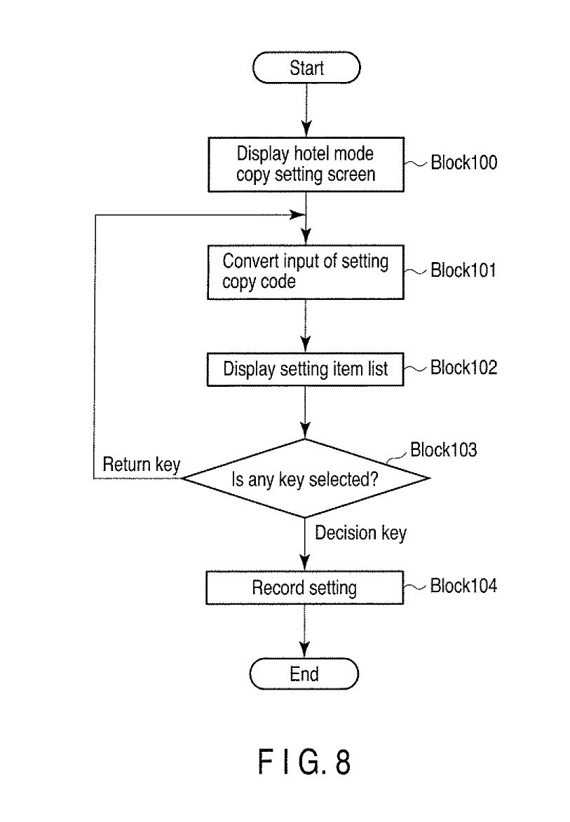

An example where the setter configures the same setting as that in the first television receiving apparatus 11 to another television receiving apparatus 11 will now be explained with reference to a hotel mode copy setting screen 80 depicted in FIG. 7 and a flowchart shown in FIG. 8.

The setter can input an instruction of displaying the hotel mode copy setting screen 80 depicted in FIG. 7 in the picture display 14 by a different special operation in which the remote controller 17 is combined with the operating module 16 of the television broadcast receiving apparatus 11 from that in the example of the hotel mode setting screen 70 shown in FIG. 4.

Based on the input, the control module 56 reads screen information of the hotel mode setting screen 70 from the nonvolatile memory 59 and displays the read information in the picture display 14 (Block 100).

A description will now be given as to the hotel mode copy setting screen 80 displayed in the picture display 14. A setting copy code input column 81r a setting item display list 82, and an operation explanation column 83 are displayed in the hotel mode copy setting screen 80.

When the hotel mode copy setting screen 80 is displayed in the picture display 14, a cursor 84 is first displayed in the setting copy code input column 81. The setter inputs a four-digit number in the setting copy code input column 81 by using the channel selection key 71b corresponding to each of 0 (10 is used in this example) to 9 in the remote controller 17 as a setting code input module.

The number input at this time is a decimal four-digit setting copy code displayed in the setting copy code column 73 when the setter sets the hotel mode setting item bit list 74 in the hotel mode setting screen 70 depicted in FIG. 4 in the first television receiving apparatus 11. In this example, as shown in FIG. 7, it is assumed that the setter inputs “1234” as the setting copy code.

The setting copy code may be displayed in a screen other than the hotel mode setting screen 70. That is, the setter can use the remote controller 17 or the operating module 16 to select a setting copy code acquisition menu with respect to the television broadcast receiving apparatus 11 in which the hotel mode setting item bit list 74 is set in the hotel mode setting screen 70. When the setting copy code acquisition menu is selected, the control module 56 displays the setting copy code display screen showing the setting copy code in the picture display 14. Therefore, the setter can visually confirm the setting copy code in the setting copy code display screen different from the hotel mode setting screen 70.

The control module 56 converts a four-digit decimal number input in the setting copy code input column 81 into a binary number in the hotel mode copy setting screen 80 depicted in FIG. 7 (Block 101).

Although not displayed in the picture display 14, the control module 56 associates the converted binary setting copy code with the information recorded in the nonvolatile memory 59 and depicted in FIGS. 5 and 6 to acquire the same hotel mode setting item bit list data as the hotel mode setting item bit list 74 shown in FIG. 4 by internal processing.

Additionally, the control module 56 as a setting value setting module can record the setting in the hotel mode setting item bit list data in the nonvolatile memory 59 and apply it to the television receiving apparatus 11. Therefore, the second and subsequent television receiving apparatuses 11 have the same settings as those in the first television receiving apparatus 11.

Further, when the setter inputs a four-digit number in the setting copy code input column 81, the control module 56 converts the decimal number into a binary setting copy code and displays the setting item display list 82 showing a volume value and on/off which are acquired in regard to the respective setting items while associating the converted binary setting copy code with the information recorded in the nonvolatile memory 59 and shown in FIGS. 5 and 6 (Block 102).

Since the setter can confirm set contents by using the setting item display list 82, the setter can readily confirm whether the contents that should be set in the television receiving apparatus 11 are correct.

Furthermore, when the setter confirms respective setting contents in the setting item display list 82 displayed in the hotel mode copy setting screen 80 and determines that an incorrect four-digit setting copy code has been input, the setter can change the setting as follows.

The setter presses the return key 17d in the remote controller 17 in accordance with the operation explanation column 83 displayed in the hotel mode copy setting screen 80. When the control module 56 confirms that the return key 17d has been pressed (Block 103), it returns the cursor 84 to the setting copy code input column 8′ and waits for a correct setting copy code to be input.

Furthermore, the setting item display list 82 displays the setting Item display list 82 in accordance with the new four-digit setting copy code input in the setting copy code input column 81 by the setter.

Moreover, when the setter determines that contents in the setting item display list 82 are correct, the setter presses the decision key 17c in the remote controller 17 in accordance with the operation explanation column 83. When the control module 56 recognizes that the decision key 17c has been pressed (Block 103), it records the setting in the nonvolatile memory 59 and applies this setting to the television receiving apparatus 11 (Block 104).

As explained above, when the setter sets the hotel mode in regard to the first television receiving apparatus 11, a four-digit setting copy code associated with the setting is obtained. When the setter sets the same hotel mode as that in the first television receiving apparatus 11 with respect to the second and subsequent television receiving apparatus 11, the setter has to do is inputting in the hotel mode copy setting screen 80 the four-digit setting copy code obtained when setting the first television receiving apparatus 1. Therefore, when the setter must carry out the same setting with respect to the plurality of television receiving apparatuses 11 in, e.g., a hotel, the setter can readily configure the setting based on the foregoing embodiment.

The above-explained setting in the hotel mode copy setting screen 80 can be modified as follows.

For example, selecting a predetermined key in the remote controller 17 preset in the hotel mode copy setting screen 80 enables returning to the hotel mode setting screen 70 shown in FIG. 4. At this time, the hotel mode setting screen 70 can reflect each setting shown in the setting item display list 82 in the hotel mode setting item bit list 74 to be displayed. Therefore, when the setter wants to partially change the setting in the television receiving apparatus 1 in a specific room, the setting can be readily changed since the setting in the first apparatus is determined as a default and the hotel mode setting item bit list 74 is displayed in the hotel mode setting screen 70.

As a result, in the setting in the second and subsequent television broadcast receiving apparatuses, just inputting a numeric code having substantially four digits obtained from the setting carried out with respect to the first television broadcast receiving apparatus by using the remote controller enables configuration of the same settings as those in the first apparatus. That is, the setting can be configured by using the remote controller alone that is attached to the television broadcast receiving apparatus without utilizing a special device, and hence the setting can be readily configured even after the television broadcast receiving apparatus is installed in the hotel. Moreover, since just operating the numeric buttons of 0 to 9 in the remote controller can suffice for the setting, ordinary people like hotel employees can easily configure the setting.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A television broadcast receiving apparatus comprising:
a recording module that records setting information set in regard to a plurality of setting items;
a display that displays a setting screen required to set setting values of the plurality of setting items;
a setting input module that input the setting information in the setting screen required to set the setting values of the plurality of setting items displayed in the display;
an acquiring module that acquires a setting code associated with the plurality of setting items in the setting screen;
a setting code input module that input the setting code; and
a setting value setting module that sets the setting values of the plurality of setting items in association with the setting code input from the setting code input module.

2. The apparatus of claim 1, wherein the setting items are constituted of a plurality of bit columns and the setting code is a value obtained by converting the setting item list constituted of the plurality of bit columns into a decimal number.

3. The apparatus of claim 2, wherein, when the setting input module moves a cursor to a specific bit column in the plurality of bit columns constituting the setting items in the setting screen, the display displays a setting name and a setting state corresponding to an item set in the specific bit column on which the cursor is displayed.

4. The apparatus of claim 1, wherein, when the setting of the setting item is changed in the setting screen, the display changes the setting code to a new setting code associated with the changed setting item and displays the new setting code.

5. The apparatus of claim 2, wherein a sound is volume that is set on a plurality of levels is set in three bit columns in the plurality of bit columns constituting the setting items, and on/off is set in regard to preset items in each of the other bit columns.

6. The apparatus of claim 1, wherein the setting value setting module acquires the same setting information as that of the specified setting item associated with the setting code based on input of the setting code by the setting input module.

7. The apparatus of claim 6, wherein the setting value setting module displays a list of a setting name and setting state in association with each other in regard to the setting of the specified setting item corresponding to the setting code based on input of the setting code by the setting input module.

8. The apparatus of claim 1, further comprising:
a control module that reads control information of the setting screen from the recording module based on a predetermined input and displays the read control information.

9. A television setting method comprising:
displaying a setting screen required to set setting values of a plurality of setting items;
inputting setting information with respect to the setting screen required to set the setting values of the plurality of setting items; and
setting the setting values of the plurality of setting items in association with a setting code corresponding to the setting of the plurality of setting items in the setting screen.
